(19) United States
(12) Patent Application Publication
(10) Pub. No.: US 2016/0033828 A1
(43) Pub. Date: Feb. 4, 2016

(54) LIQUID CRYSTAL DISPLAY

(71) Applicant: Samsung Display Co., Ltd., Yongin-City (KR)

(72) Inventors: Cheol Shin, Yongin-City (KR); Haksun Chang, Yongin-City (KR); Kaeun Kim, Yongin-City (KR); Kichul Shin, Yongin-City (KR); Hokil Oh, Yongin-City (KR); Sehyun Lee, Yongin-City (KR)

(21) Appl. No.: 14/670,115

(22) Filed: Mar. 26, 2015

(30) Foreign Application Priority Data
Jul. 30, 2014 (KR) 10-2014-0097614

(51) Int. Cl. G02F 1/1343

(52) U.S. Cl. CPC G02F 1/134309; G02F 2001/134345

(57) ABSTRACT

Provided is a liquid crystal display. The liquid crystal display includes a pair of substrates and a pixel electrode and a common electrode provided on the pair of substrates and facing each other. The pixel electrode includes a plurality of minute branch electrodes alternating with each other.

### CLAIM OF PRIORITY

This application claims the benefit of Korean Patent Application No. 10-2014-0097614, filed on Jul. 30, 2014, in the Korean Intellectual Property Office, the disclosure of which is incorporated herein in its entirety by reference.

### BACKGROUND OF THE INVENTION

1. Field of the Invention

One or more embodiments of the present invention generally relate to liquid crystal displays, and more particularly, to liquid crystal displays having improved bruising characteristics.

2. Description of the Related Art

Displays are required in computer monitors, televisions, mobile phones, portable terminals, and the like. Examples of the most widely used flat panel displays include liquid crystal displays and organic light-emitting displays.

A liquid crystal display is one of the most widely used flat panel displays and includes two flat panels, in which a pixel electrode and a common electrode are formed, and a liquid crystal layer interposed between the two flat panels. The liquid crystal display displays an image by controlling the polarization of light passing through the liquid crystal layer, by applying a voltage to the pixel electrode or the common electrode to form an electric field in the liquid crystal layer to change the alignment of liquid crystal molecules of the liquid crystal layer.

Vertically aligned mode liquid crystal displays, in which the major axes of liquid crystal molecules are vertically aligned with respect to a display panel when no voltage is applied thereto, have been developed.

A patterned vertical alignment (PVA) mode liquid crystal display has been developed as a kind of vertically aligned mode liquid crystal display to provide a wide viewing angle. In the PVA mode liquid crystal display, minute slits are formed in electrodes so that liquid crystal molecules may be aligned in different directions by an electric field formed between patterned transparent electrodes. When a minute slit is formed in an electrode as above, an unstable texture may be generated by a strong fringe field generated in a symmetrical region of the minute slit and thus bruising characteristics may be degraded.

### SUMMARY OF THE INVENTION

One or more embodiments of the present invention include liquid crystal displays that are designed to improve bruising characteristics by reducing the generation of an unstable texture even when a minute slit is formed in an electrode.

Additional aspects will be set forth in part in the description which follows and, in part, will be apparent from the description, or may be learned by practice of the presented embodiments.

According to one or more embodiments of the present invention, a liquid crystal display includes: a pair of substrates; and a pixel electrode and a common electrode disposed on the pair of substrates to face each other, the pixel electrode comprising a plate electrode, a plurality of first minute branch electrodes extending inward from the plate electrode and alternating with each other, and a plurality of second minute branch electrodes extending outward from the plate electrode.

The pixel electrode may include: a cross pattern at a center of the pixel electrode; and the plate electrode surrounding the cross pattern, wherein the plurality of first minute branch electrodes extend in a diagonal direction inward from the plate electrode and up to the cross pattern.

The pixel electrode includes a partial extension structure formed in at least one of a partial boundary region located between the plate electrode and the plurality of first minute branch electrodes and a partial boundary region located between the plate electrode and the plurality of second minute branch electrodes.

The common electrode may include a slit pattern formed at a position corresponding to the plate electrode and having a smaller width than the plate electrode.

An electrode portion formed inside the slit pattern of the common electrode may have a diamond shape.

The slit pattern of the common electrode may include portions of different widths.

The cross pattern may include a horizontal slit and a vertical slit that cross each other and the plurality of first minute branch slits alternate with each other with respect to the horizontal slit and the vertical slit.

At least one of the horizontal slit and the vertical slit may include a slope portion having a width increasing toward a cross point thereof.

At least one of the horizontal slit and the vertical slit may have a uniform width.

A first subpixel region and a second subpixel region may be provided in a pixel region, the common electrode and the pixel electrode may be formed in each of the first subpixel region and the second subpixel region, the horizontal slit and the vertical slit of the cross pattern may have a first width in one of the first subpixel region and the second subpixel region, and in the other of the first subpixel region and the second subpixel region, the horizontal slit of the cross pattern may have a width smaller than the first width and the vertical slit of the cross pattern may have a width larger than the first width.

According to one or more embodiments of the present invention, a liquid crystal display includes: a pair of substrates; and a pixel electrode and a common electrode disposed on the pair of substrates to face each other, the pixel electrode comprising a first plate electrode and a second plate electrode that are adjacent to each other, a plurality of first minute branch electrodes extending in a diagonal direction outward from the first plate electrode, and a plurality of second minute branch electrodes extending in a diagonal direction outward from the second plate electrode, and the plurality of first minute branch electrodes and the plurality of second minute branch electrodes may alternate with each other between the first plate electrode and the second plate electrode.

A distance between the first minute branch electrode and the second minute branch electrode may be uniform between the first plate electrode and the second plate electrode.

The first plate electrode and the second plate electrode may have a diamond shape, and the plurality of first minute branch electrodes and the plurality of second minute branch electrodes may extend in a diagonal direction from sides of the first plate electrode and the second plate electrode.

The first plate electrode and the second plate electrode may have a diamond shape, and the plurality of first minute branch electrodes and the plurality of second minute branch electrodes may extend in a diagonal direction from sides of the first plate electrode and the second plate electrode.

A first subpixel region and a second subpixel region may be provided in a pixel region, and the common electrode and the pixel electrode may be formed in each of the first subpixel region and the second subpixel region.

In the liquid crystal display according to one or more embodiments of the present invention, since a minute slit is formed in the pixel electrode to provide a plurality of minute branch electrodes and at least some of the plurality of minute branch electrodes alternate with each other, the generation of an unstable texture may be reduced and thus bruising characteristics may be improved.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic cross-sectional view of a liquid crystal display according to an embodiment of the present invention;

FIG. 2 illustrates an electrode structure of a liquid crystal display according to an embodiment of the present invention;

FIG. 3 illustrates a common electrode of FIG. 2;

FIG. 4A illustrates a portion of FIG. 2;

FIG. 4B illustrates a light-transmitted image in the electrode structure of FIG. 4A;

FIG. 4C is an enlarged view of a portion A of FIG. 4A, which illustrates an alternating structure of first minute branch electrodes;

FIG. 4D illustrates an alignment of a liquid crystal (LC) director in the portion A of FIG. 4A when a voltage is applied thereto;

FIG. 5A illustrates a portion of an electrode structure in a comparative example;

FIG. 5B illustrates a light-transmitted image in the electrode structure of FIG. 5A;

FIG. 5C is an enlarged view of a portion B of FIG. 5A, which illustrates an alternating structure of first minute branch electrodes;

FIG. 5D illustrates an alignment of an LC director in the portion B of FIG. 5A when a voltage is applied thereto;

FIG. 6 illustrates an electrode structure of a liquid crystal display according to another embodiment of the present invention;

FIG. 7 illustrates a light-transmitted image in the electrode structure of FIG. 6;

FIG. 8 illustrates a light-transmitted image in a comparative example;

FIG. 9 illustrates a pixel structure of a liquid crystal display according to another embodiment of the present invention;

FIG. 10 illustrates a light-transmitted image in the pixel structure of FIG. 9;

FIG. 11 illustrates a comparative example of the pixel structure of FIG. 9;

FIG. 12 illustrates a light-transmitted image in the comparative example of FIG. 11;

FIG. 13 illustrates a pixel structure of a liquid crystal display according to another embodiment of the present invention;

FIG. 14 illustrates a light-transmitted image in the pixel structure of FIG. 13; and

FIG. 15 illustrates an electrode structure of a liquid crystal display according to another embodiment of the present invention.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present invention may include various embodiments and modifications, and exemplary embodiments thereof are illustrated in the drawings and will be described herein in detail. The effects and features of the present invention and the accomplishing methods thereof will become apparent from the following description of the embodiments, taken in conjunction with the accompanying drawings. However, the prevent invention is not limited to the embodiments described below, and may be embodied in various modes.

Hereinafter, embodiments of the present invention will be described in detail with reference to the accompanying drawings. In the following description, like reference numerals denote like elements, and redundant descriptions thereof will be omitted.

It will be understood that although the terms “first”, “second”, etc. may be used herein to describe various components, these components should not be limited by these terms. These terms are only used to distinguish one component from another.

As used herein, the singular forms “a”, “an” and “the” are intended to include the plural forms as well, unless the context clearly indicates otherwise.

It will be further understood that the terms “comprise”, “include” and “have” used herein specify the presence of stated features or components, but do not preclude the presence or addition of one or more other features or components.

It will be understood that when a layer, region, or component is referred to as being “formed on” another layer, region, or component, it may be directly or indirectly formed on the other layer, region, or component. That is, for example, intervening layers, regions, or components may be present.

Sizes of components in the drawings may be exaggerated for convenience of description. In other words, since sizes and thicknesses of components in the drawings are arbitrarily illustrated for convenience of description, the following embodiments are not limited thereto.

A liquid crystal display according to an embodiment of the present invention includes: a pair of substrates; and a pixel electrode and a common electrode provided on the pair of substrates and facing each other. One of the pair of substrates may be a lower substrate, and the other of the pair of substrates may be an upper substrate. The pixel electrode may include a plurality of minute branch electrodes, and at least some of the plurality of minute branch electrodes may alternate with each other to reduce the generation of an unstable texture. Since the generation of an unstable texture is reduced, bruising characteristics may be improved. Hereinafter, a case where the pixel electrode having a partial extension structure of a plate electrode is provided on the lower substrate and the common electrode is provided on the upper substrate will be described as an example.

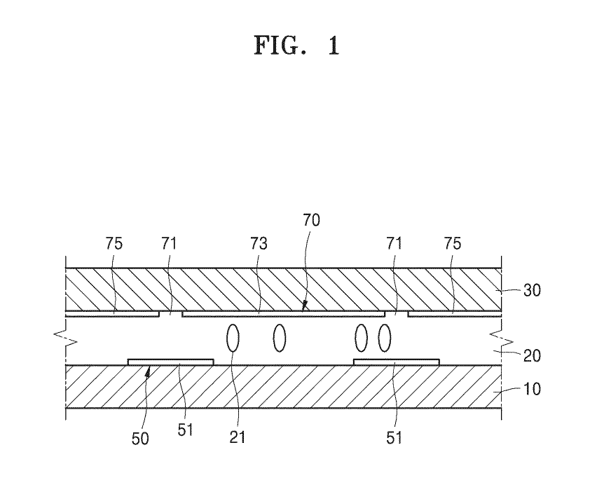

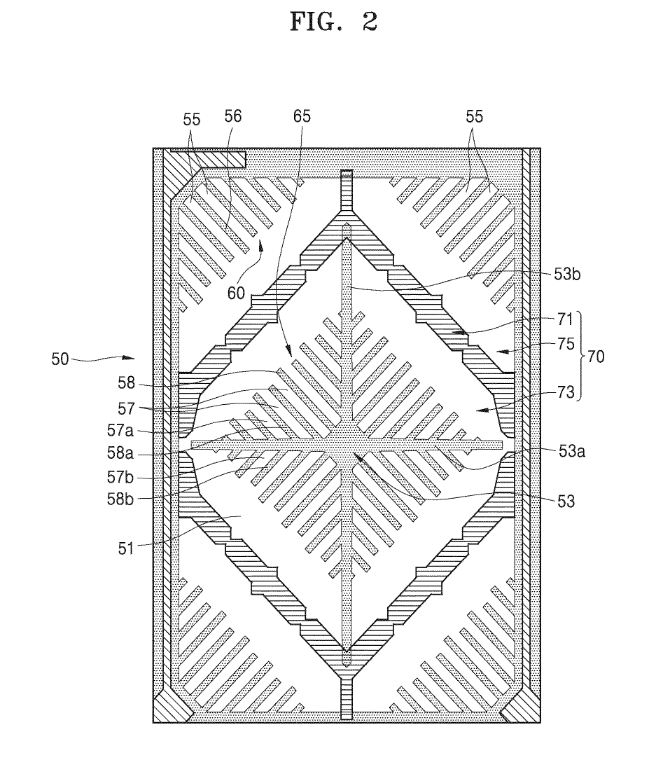

FIG. 1 is a schematic cross-sectional view of a liquid crystal display according to an embodiment of the present invention. FIG. 2 illustrates an electrode structure of a liquid crystal display according to an embodiment of the present invention.

Referring to FIGS. 1 and 2, the liquid crystal display according to an embodiment of the present invention includes a lower substrate (e.g., first substrate) 10, an upper substrate (e.g., second substrate) 30, and a liquid crystal layer 20 interposed between the lower substrate 10 and the upper substrate 30.

The lower substrate 10 and the upper substrate 30 may be formed of an insulating substrate such as a glass or plastic substrate. An alignment layer (not shown) may be formed on inner surfaces of the lower substrate 10 and the upper substrate 30, and the alignment layer may be a vertical alignment layer. A polarizer (not shown) may be provided on outer surfaces of the lower substrate 10 and the upper substrate 30. In this case, transmission axes of two polarizers may be disposed to be perpendicular to each other. Herein, the liquid crystal display according to an embodiment of the present invention may be a reflection type, and in this case, the polarizer may be disposed only on a light emitting surface, for example, the outer surface of the upper substrate 30.

The liquid crystal layer 20 may be a vertically aligned mode in which the major axes of molecules of liquid crystal 21 are vertically aligned with respect to the lower substrate 10 and the upper substrate 30 when no voltage is applied thereto, or may be a patterned vertical alignment (PVA) mode in which electrodes are patterned. For example, the liquid crystal 21 of the liquid crystal layer 20 may have negative dielectric anisotropy. When the polarizers are disposed respectively on the outer surfaces of the lower substrate 10 and the upper substrate 30 to be perpendicular to each other, light that has passed through one of the polarizers with no electric field in the liquid crystal layer 20 fails to pass through the other of the polarizers (analyzer).

For example, a pixel electrode 50 may be provided on the lower substrate 10, and a common electrode 70 may be provided on the upper substrate 30. Although a case where the pixel electrode 50 is provided on the lower substrate 10 and the common electrode 70 is provided on the upper substrate 30 will be described as an example, embodiments of the present invention are not limited thereto. Also, the lower substrate 10 and the upper substrate 30 are relative concepts used to describe the embodiments of the present invention. The embodiments of the present invention are not limited to a case where the lower substrate 10 is located at a lower side and the upper substrate 30 is located at an upper side, and from the viewpoint of a viewer, the lower substrate 10 may be located at a rear side and the upper substrate 30 may be located at a front side.

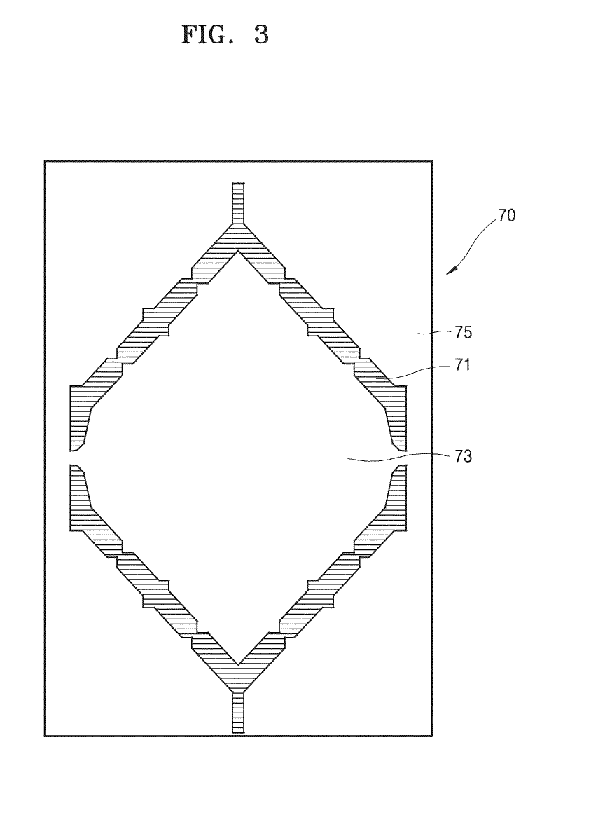

FIG. 2 illustrates a state where the common electrode 70 provided on the upper substrate 30 is superimposed on the pixel electrode 50 provided on the lower substrate 10. FIG. 3 illustrates the common electrode 70 of FIG. 2.

Referring to FIG. 2, the pixel electrode 50 includes: a cross pattern 53 at a center thereof; a plate electrode 51 surrounding the cross pattern 53; and a plurality of first minute branch electrodes 57 extending in a diagonal direction inward from the plate electrode 51 and up to the cross pattern 53. The pixel electrode 50 may further include a plurality of second minute branch electrodes 55 extending outward from the plate electrode 51. Partial extension structures 60 and 65 of the plate electrode 51 may be formed in at least partial boundary regions between the plate electrode 51 and the plurality of minute branch electrodes 55 and 57. Herein, without the partial extension structures 60 and 65 of the plate electrode 51, end portions of the plurality of minute branch electrodes 55 and 57 may be ended at predetermined positions.

The cross pattern 53 may include a horizontal slit 53a and a vertical slit 53b that cross each other. The cross pattern 53 may be empty or may be filled with a material (e.g., insulating material) other than an electrode material. At least one of the horizontal slit 53a and the vertical slit 53b may include a slope portion having a width increasing toward a cross point thereof. FIG. 2 illustrates an example in which both the horizontal slit 53a and the vertical slit 53b include a slope portion having a width increasing toward a cross point thereof.

The plate electrode 51 may be formed to surround the cross pattern 53 and may be formed to have, for example, a substantially diamond shape.

FIG. 2 illustrates an exemplary case where the plurality of first and second minute branch electrodes 55 and 57 are provided inside and outside the plate electrode 51. That is, the pixel electrode 50 may include: a plurality of first minute branch electrodes 57 extending inward from the plate electrode 51 and up to the cross pattern 53; and a plurality of second minute branch electrodes 55 extending outward from the plate electrode 51.

For example, a cross pattern 53 is formed at a center thereof and a plurality of slits 58 are formed in the cross pattern 53 in a diagonal direction to form a slit cross pattern, so that the pixel electrode 50 may include the plurality of first minute branch electrodes 57 extending in a diagonal direction inward from the plate electrode 51 and up to the cross pattern 53. Also, a plurality of slits 56 are formed in a diagonal direction outward from the plate electrode 51, so that the pixel electrode 50 may include the plate electrode 51 and the plurality of second minute branch electrodes 55 extending in a diagonal direction outward from the plate electrode 51.

The plurality of first minute branch electrodes 57 may be formed to alternate with each other with respect to the horizontal slit 53a and the vertical slit 353b of the cross pattern 53. For example, as illustrated in FIG. 2, slits 58a formed on one side of the horizontal slit 53a and slits 58b formed on the opposite side of the horizontal slit 53a may alternate with each other, so that first minute branch electrodes 57a located on one side of the horizontal slit 53a and first minute branch electrodes 57b located on the opposite side of the horizontal slit 53a may alternate with each other.

The partial extension structures 65 and 60 of the plate electrode 51 may be formed in at least a partial boundary region located between the plate electrode 51 and at least one of the first minute branch electrode 57 and the second minute branch electrode 55. For example, the partial extension structure 65 of the plate electrode 51 may be formed in at least a partial boundary region located between the plate electrode 51 and the plurality of first minute branch electrodes 57. Also, the partial extension structure 60 of the plate electrode 51 may be formed in at least a partial boundary region located between the plate electrode 51 and the plurality of second minute branch electrodes 55. FIG. 2 illustrates an exemplary case where the partial extension structures 65 and 60 of the plate electrode 51 are respectively formed in at least a partial boundary region located between the plate electrode 51 and the plurality of first minute branch electrodes 57 and at least a partial boundary region located between the plate electrode 51 and the plurality of second minute branch electrodes 55.

The partial extension structures 65 and 60 of the plate electrode 51 may be formed by partially extending the plate electrode 51 in the shape of stepping stones. In this case, at least one slit 56, 58 is located between regions that are formed by partially extending the plate electrode 51 in the shape of stepping stones.

For example, the partial extension structures 65 and 60 of the plate electrode 51 may be formed in a region where the plurality of minute branch electrodes 55 and 57 have a maximum length. That is, when the plate electrode 51 is formed in a substantially diamond shape having the cross pattern 53 or a slit cross pattern at a center thereof, a region where the plurality of second minute branch electrodes 55 have a maximum length is a portion extending to four corners of the pixel, and a region where the plurality of first minute branch electrodes 57 have a maximum length is a portion extending from four corners of the pixel to a center of the cross pattern 53. The plate electrode 51 may be partially extended in the shape of stepping stones in a region where the plurality of minute branch electrodes 55 and 57 have a maximum length.

For example, the plurality of minute branch electrodes 57 and 55 may be formed to have a length of about 30 μm or less, and in this case, the partial extension structures 65 and 60 of the plate electrode 51 may be formed in the shape of stepping stones in a region where the plurality of minute branch electrodes 57 and 55 have a length greater than, for example, about 29 μm. In this case, the partial extension structures 65 and 60 of the plate electrode 51 may be formed to have a length of about 5 μm or less.

Herein, the partial extension structures 65 and 60 of the plate electrode 51 may not be a portion extending to four corners of the pixel and/or a portion extending to the opposite side thereof and may be formed at other boundary positions of the plate electrode 51 and the plurality of minute branch electrodes 57 and 55.

As described above, by forming the plurality of minute branch electrodes 57 and 55 in the diagonal direction with respect to the cross pattern 53, the pixel electrode 50 is divided into four regions by the horizontal slit 53a and the vertical slit 53b and each of the four regions includes the plurality of minute branch electrodes 57 and 55 extending in the diagonal direction. Therefore, when a voltage is applied to the pixel electrode 50, the molecules of the liquid crystal 21 tilt in about four directions. In this manner, when the molecules of the liquid crystal 21 tilt in various directions, a reference viewing angle of the liquid crystal display may be increased.

As described above, when the pixel electrode 50 is formed to include the plate electrode 51 and the plurality of minute branch electrodes 57 and 55, the liquid crystal display having a high aperture ratio may be implemented. Also, since the plate electrode 51 is partially extended in the shape of stepping stones in a partial boundary region located between the plate electrode 51 and the minute branch electrodes 57 and 55, for example, a region where the minute branch electrodes 57 and 55 have a maximum strength, the liquid crystal control length may be extended without response time delay of the liquid crystal.

Referring to FIGS. 2 and 3, the common electrode 70 may include a slit pattern 71 that is formed with a smaller width than the plate electrode 51 at a position corresponding to the plate electrode 51 of the pixel electrode 50. FIG. 2 illustrates a disposition relation between the plate electrode 51 of the pixel electrode 50 and the slit pattern 71 of the common electrode 70.

A common electrode portion 73 inside the slit pattern 71 may be formed to have a substantially diamond shape. In this case, a distance between the slit pattern 71 and a boundary between the plate electrode 51 and the plurality of minute branch electrodes 57 and 55 may be, for example, about 15 μm to about 30 μm. In this case, the slit pattern 71 may be formed to have one or more portions of different widths.

Due to the slit pattern 71 having a diamond shape having a width, the common electrode 70 includes the common electrode portion 73 having a substantially diamond shape and located at a center thereof and a common electrode portion 75 outside the slit pattern 71.

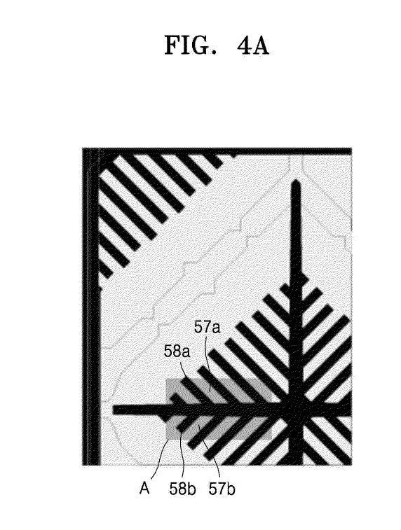

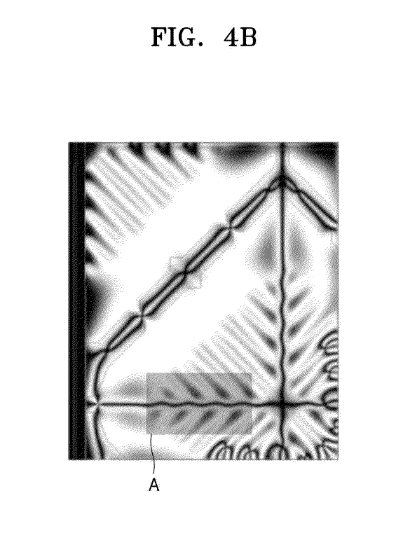

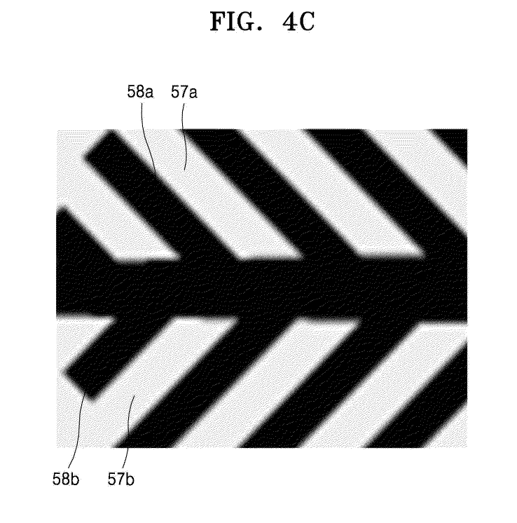

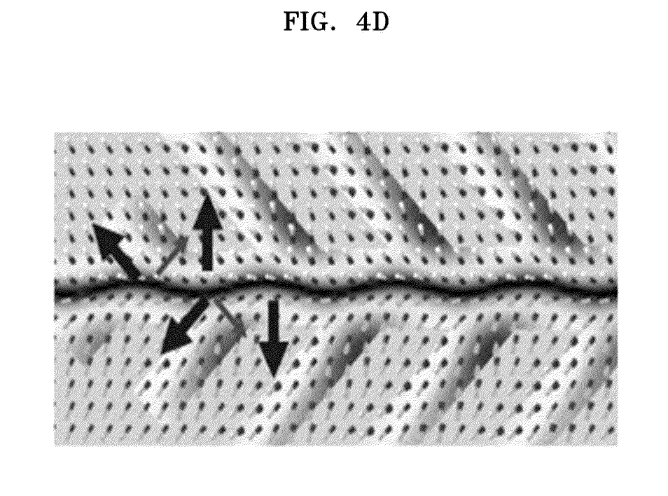

FIG. 4A illustrates a portion of FIG. 2, and FIG. 4B illustrates a light-transmitted image in the electrode structure of FIG. 4A. FIG. 4C is an enlarged view of a portion A of FIG. 4A, which illustrates an alternating structure of the first minute branch electrodes 57a and 57b. FIG. 4D illustrates an alignment of a liquid crystal (LC) director in the portion A of FIG. 4A when a voltage is applied thereto.

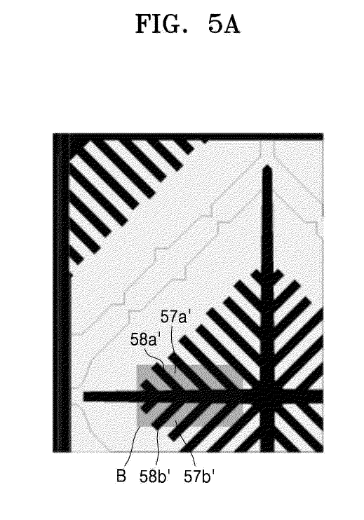

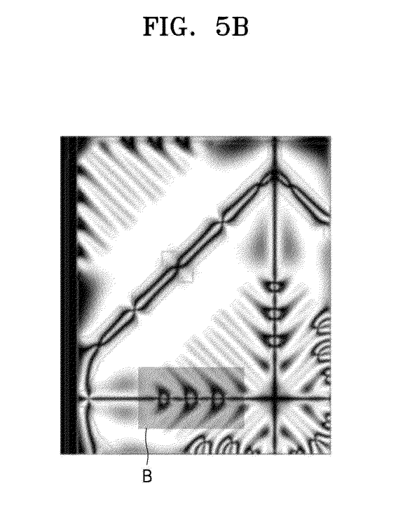

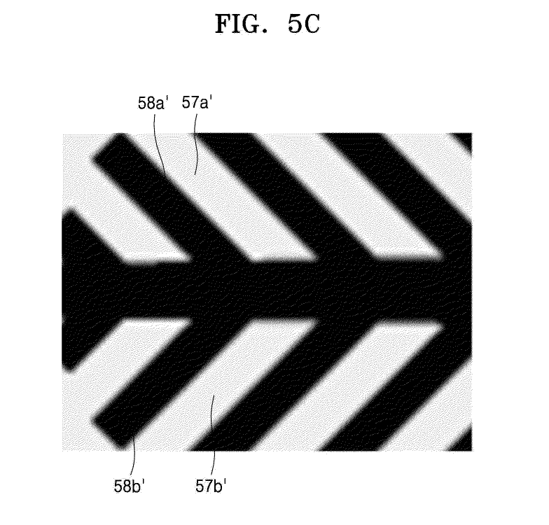

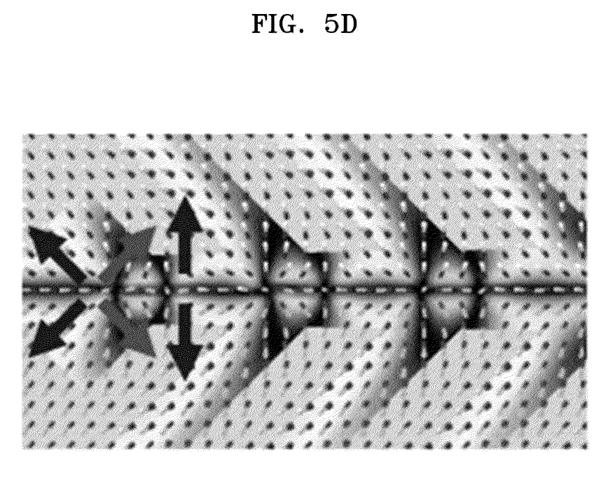

FIG. 5A illustrates a portion of an electrode structure in a comparative example, and FIG. 5B illustrates a light-transmitted image in the electrode structure of FIG. 5A. FIG. 5C is an enlarged view of a portion B of FIG. 5A, which illustrates an alternating structure of first minute branch electrodes 57a′ and 57b′. FIG. 5D illustrates an alignment of an LC director in the portion B of FIG. 5A when a voltage is applied thereto.

When the pixel electrode 50 is patterned to form the slits 58a and 58b alternating with each other such that the first minute branch electrodes 57a and 57b alternate with each other as illustrated in FIGS. 4A and 4C, since a fringe field is not strongly generated as illustrated in FIG. 4D, the generation of an unstable texture may be prevented and thus bruising may be prevented as illustrated in FIG. 4B.

On the other hand, when the pixel electrode 50 is patterned to form slits 58a′ and 58b′ that are opposite to each other such that minute branch electrodes 57a′ and 57b′ are opposite to each other as illustrated in FIGS. 5A and 5C, since a fringe field is strongly generated as illustrated in FIG. 5D, an unstable texture may be generated and thus bruising may be greatly generated as illustrated in FIG. 5B.

As may be seen from the comparison between the alternating structure of the first minute branch electrodes 57a and 57b according to an embodiment of the present invention and the comparative example in which the minute branch electrodes 57a′ and 57b′ do not have an alternating structure, in the liquid crystal display according to an embodiment of the present invention, since the first minute branch electrodes 57 are formed to alternate with each other with respect to the horizontal slit 53a and the vertical slit 53b of the cross pattern 53, the generation of an unstable texture may be reduced and thus bruising characteristics may be improved.

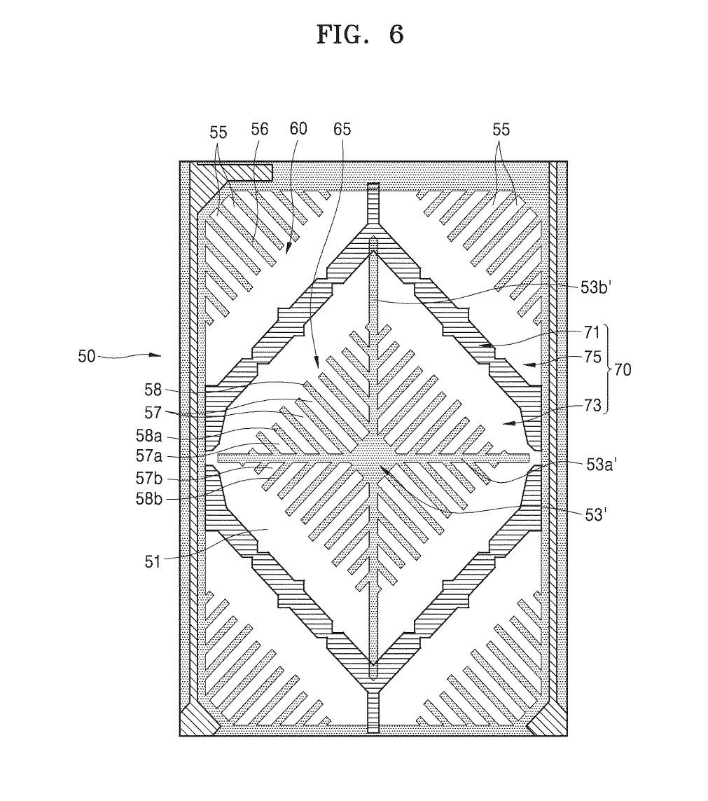

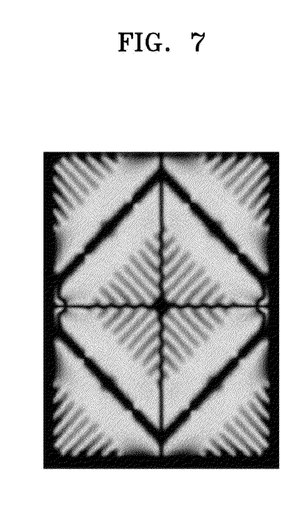

FIG. 6 illustrates an electrode structure of a liquid crystal display according to another embodiment of the present invention. FIG. 7 illustrates a light-transmitted image in the electrode structure of FIG. 6. The electrode structure of FIG. 6 is different from the electrode structure of FIG. 2 in that at least one of a horizontal slit 53a′ and a vertical slit 53b′ of a cross pattern 53′ has a uniform width instead of a slope. FIG. 6 illustrates an example in which both the horizontal slit 53a′ and the vertical slit 53b′ have a uniform width.

As may be seen from FIGS. 6 and 7, when the first minute branch electrodes 57 are formed to alternate with each other with respect to the horizontal slit 53a′ and the vertical slit 53b′, texture and bruising characteristics may be improved. Therefore, since the horizontal slit 53a′ and the vertical slit 53b′ of the cross pattern 53′ have a uniform width instead of a slope, a transmittance may be further improved.

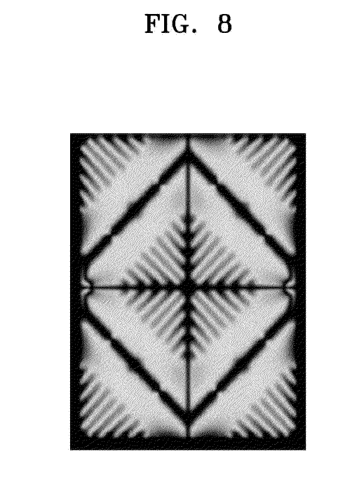

FIG. 8 illustrates a light-transmitted image in a comparative example. In detail, FIG. 8 illustrates a light-transmitted image in a case where a horizontal slit and a vertical slit have a slope and minute branch electrodes are opposite to each other with respect to the horizontal slit and the vertical slit as illustrated in FIG. 5A. As may be seen from FIGS. 7 and 8, according to another embodiment of the present invention, when the first minute branch electrodes 57 are formed to alternate with each other with respect to the horizontal slit 53a′ and the vertical slit 53b′ and the horizontal slit 53a′ and the vertical slit 53b′ of the cross pattern 53′ has a uniform width, texture and bruising characteristics may be improved and a transmittance may be improved.

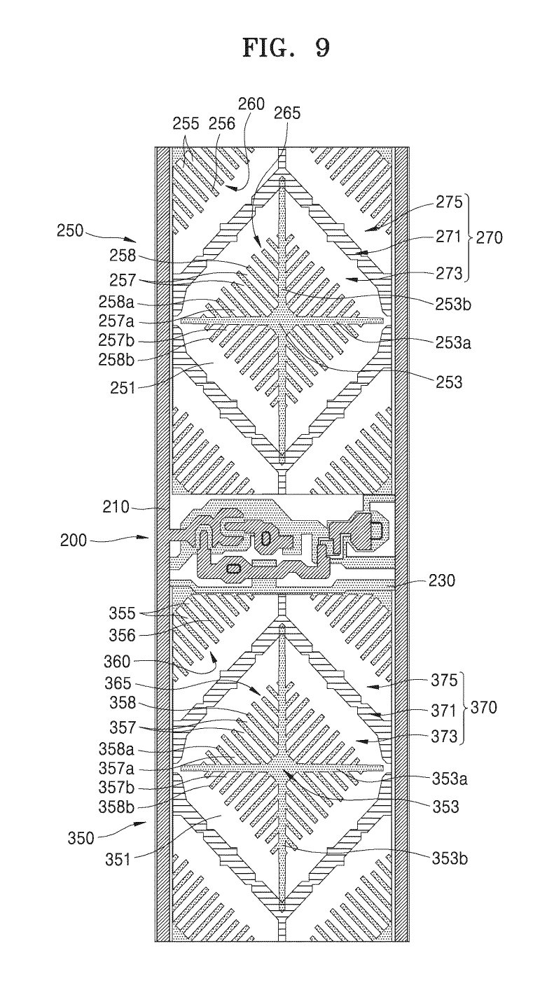

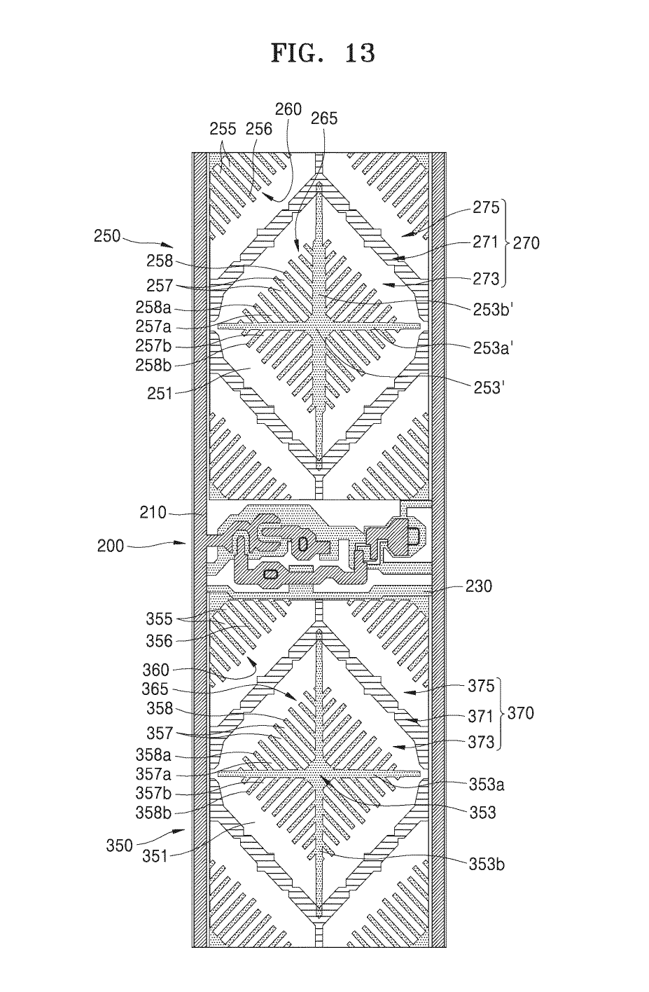

In the liquid crystal display, in order to approximate side visibility to front visibility, a pixel may be divided into, for example, two subpixels and different voltages may be applied to the two subpixels to provide different transmittances. The alternating structure of the first minute branch electrodes 57 according to an embodiment of the present invention may also be applied to a structure in which a pixel is divided into two subpixels as illustrated in FIGS. 9 and 13.

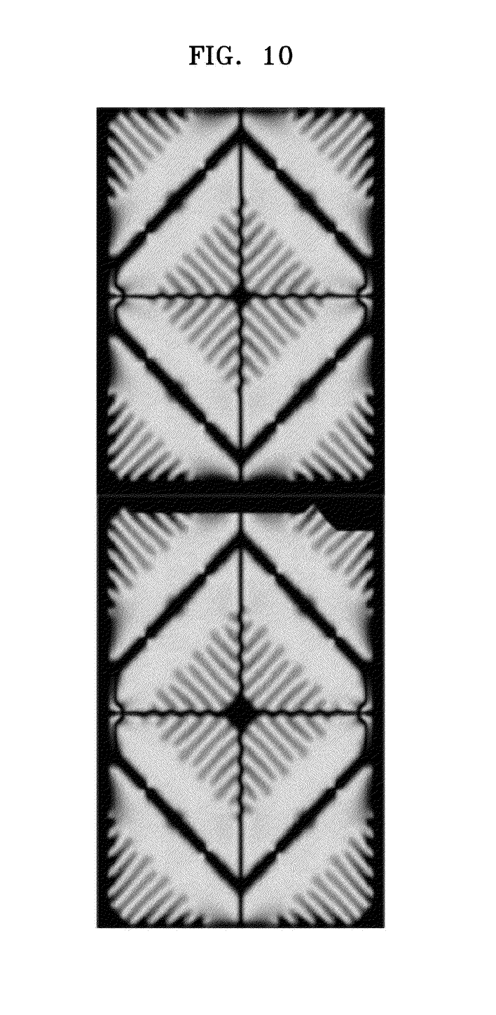

FIG. 9 illustrates a pixel structure of a liquid crystal display according to another embodiment of the present invention. FIG. 10 illustrates a light-transmitted image in the pixel structure of FIG. 9.

Referring to FIG. 9, a pixel region may include a first subpixel region 250 and a second subpixel region 350. A switching driving unit 200 may be disposed between the first subpixel region 250 and the second subpixel region 350. A gate line 230 may extend in a horizontal direction, that is, an x direction and may be connected to a gate of the switching driving unit 200 to transmit a gate signal. A data line 210 may extend in a vertical direction, that is, a y direction and may be connected to a source of the switching driving unit 200 to transmit a data signal.

The pixel electrode and the common electrode according to the above-described embodiments may be formed in each of the first subpixel region 250 and the second subpixel region 350. FIG. 9 illustrates an example in which the electrode structure of FIG. 2 is applied to the first subpixel region 250 and the second subpixel region 350. The electrode structure of FIG. 6 may be applied to at least one of the first subpixel region 250 and the second subpixel region 350.

Referring to FIGS. 1 and 9, for example, in the first subpixel region 250, a pixel electrode 250 may be disposed on the lower electrode 10 and a common electrode 270 may be disposed on the upper substrate 30. Here, same reference number is used for the first subpixel region and the pixel electrode of the first subpixel region, for convenience of description. The pixel electrode 250 may include: a cross pattern 253 at a center thereof; a plate electrode 251 surrounding the cross pattern 253; and a plurality of first minute branch electrodes 257 extending in a diagonal direction inward from the plate electrode 251 and up to the cross pattern 253, and may further include a plurality of second minute branch electrodes 255 extending outward from the plate electrode 251.

The cross pattern 253 may be formed to have a structure in which a horizontal slit 253a and a vertical slit 253b cross each other. At least one of the horizontal slit 253a and the vertical slit 253b may be formed to have a slope. The first minute branch electrodes 257 may be formed to alternate with each other with respect to the horizontal slit 253a and the vertical slit 253b. For example, slits 258a formed on one side of the horizontal slit 253a and slits 258b formed on the opposite side of the horizontal slit 253a may alternate with each other, so that first minute branch electrodes 257a located on one side of the horizontal slit 253a and first minute branch electrodes 257b located on the opposite side of the horizontal slit 253a may alternate with each other. Partial extension structures 265 and 260 of the plate electrode 251 may be formed in at least partial boundary regions between the plate electrode 251 and the plurality of minute branch electrodes 257 and 255. The common electrode 270 may include a slit pattern 271 that is formed with a smaller width than the plate electrode 251 at a position corresponding to the plate electrode 251 of the pixel electrode 250. The partial extension structures 265 and 260 of the plate electrode 251 may be formed in shape of stepping stones, and one or more slits 256 and 258 may be located between the partial extension structures 265 and 260. The common electrode 270 may include a common electrode portion 273 having a substantially diamond shape and located inside the slit pattern 271 and a common electrode portion 275 located outside the slit pattern 271.

Also, in the second subpixel region 350, a pixel electrode 350 may be disposed on the lower electrode 10 and a common electrode 370 may be disposed on the upper substrate 30. Here, same reference number is used for the second subpixel region and the pixel electrode of the second subpixel region, for convenience of description. The pixel electrode 350 may include: a cross pattern 353 at a center thereof; a plate electrode 351 surrounding the cross pattern 353; and a plurality of first minute branch electrodes 357 extending in a diagonal direction inward from the plate electrode 351 and up to the cross pattern 353, and may further include a plurality of second minute branch electrodes 355 extending outward from the plate electrode 351.

The cross pattern 353 may be formed to have a structure in which a horizontal slit 353a and a vertical slit 353b cross each other. At least one of the horizontal slit 353a and the vertical slit 353b may be formed to have a slope. The first minute branch electrodes 357 may be formed to alternate with each other with respect to the horizontal slit 353a and the vertical slit 353b. For example, slits 358a formed on one side of the horizontal slit 353a and slits 358b formed on the opposite side of the horizontal slit 353a may alternate with each other, so that first minute branch electrodes 357a located on one side of the horizontal slit 353a and first minute branch electrodes 357b located on the opposite side of the horizontal slit 353a may alternate with each other. Partial extension structures 365 and 360 of the plate electrode 351 may be formed in at least partial boundary regions between the plate electrode 351 and the plurality of minute branch electrodes 357 and 355. The common electrode 370 may include a slit pattern 371 that is formed with a smaller width than the plate electrode 351 at a position corresponding to the plate electrode 351 of the pixel electrode 350. The cross pattern 353 may be formed to have a structure in which a horizontal slit 353a and a vertical slit 353b cross each other. The partial extension structures 365 and 360 of the plate electrode 351 may be formed in shape of stepping stones, and one or more slits 358 and 356 may be located between the partial extension structures 365 and 360. The common electrode 370 may include a common electrode portion 373 having a substantially diamond shape and located inside the slit pattern 371 and a common electrode portion 375 located outside the slit pattern 371.

The first subpixel region 250 may be formed to be smaller than the second subpixel region 350. When a high voltage is applied in a vertically aligned structure of liquid crystal, response delay may occur in the plate electrode 251 due to the realignment of the LC director. Therefore, the partial extension structures 265 and 260 of the plate electrode 251 of the first subpixel region 250 may be formed to be smaller than the partial extension structures 365 and 360 of the plate electrode 351 of the second subpixel region 350, to prevent response time delay in the first subpixel region 250.

According to the above pixel structure, as may be seen from FIG. 10, when the pixel electrode 250 is patterned to form the slits 258a and 258b alternating with each other such that the first minute branch electrodes 257a and 257b alternate with each other, the generation of an unstable texture may be prevented and thus bruising may be prevented. Also, when the pixel electrode 350 is patterned to form the slits 358a and 358b alternating with each other such that the first minute branch electrodes 357a and 357b alternate with each other, the generation of an unstable texture may be prevented and thus bruising may be prevented.

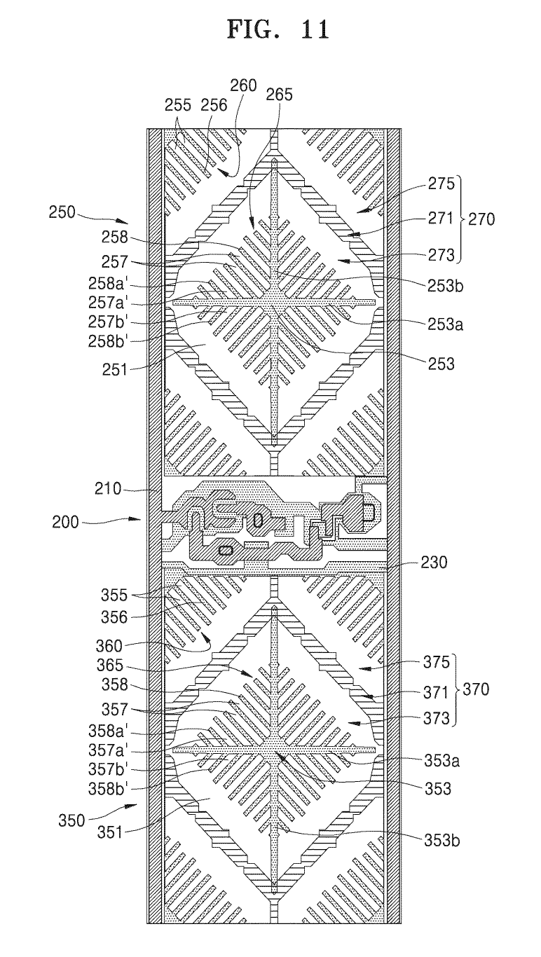

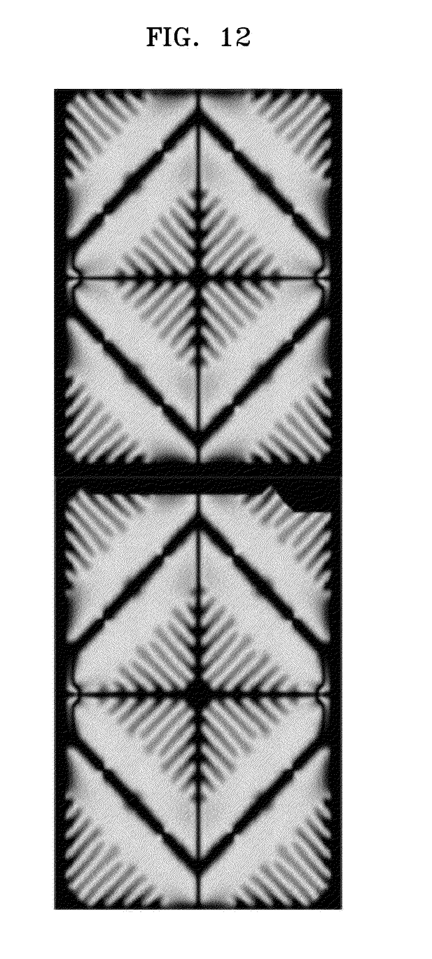

FIG. 11 illustrates a comparative example of the pixel structure of FIG. 9. In detail, FIG. 11 illustrates a case where slits 258a′ and 258b′ are formed to be opposite to each other in a first subpixel region 250 such that first minute branch electrodes 257a′ and 257b′ are formed to be opposite to each other, and slits 358a′ and 358b′ are formed to be opposite to each other in a second subpixel region 350 such that first minute branch electrodes 357a′ and 357b′ are formed to be opposite to each other. FIG. 12 illustrates a light-transmitted image in the comparative example of FIG. 11.

As may be seen from FIG. 12, when the first minute branch electrodes 257a′ and 257b′ are formed to be opposite to each other in the first subpixel region 250 and the first minute branch electrodes 357a′ and 357b′ are formed to be opposite to each other in the second subpixel region 350, an unstable texture is generated and thus bruising is generated.

Even when the pixel region includes two subpixel regions as described above, as may be seen from the comparison between the alternating structure of the first minute branch electrodes and the comparative example in which the minute branch electrodes do not have an alternating structure, in the liquid crystal display according to an embodiment of the present invention, since the first minute branch electrodes are formed to alternate with each other with respect to the horizontal slit and the vertical slit of the cross pattern, the generation of an unstable texture may be reduced and thus bruising characteristics may be improved.

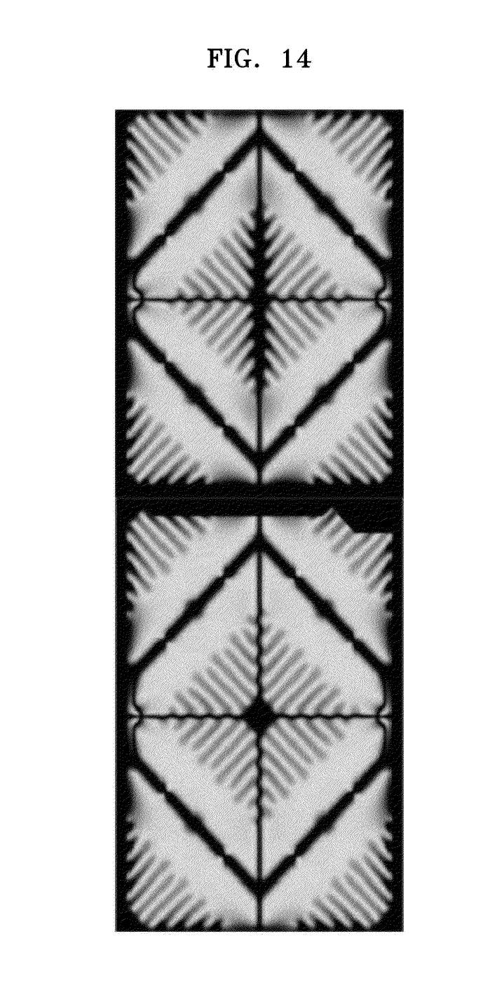

FIG. 13 illustrates a pixel structure of a liquid crystal display according to another embodiment of the present invention. FIG. 14 illustrates a light-transmitted image in the pixel structure of FIG. 13.

The electrode structure of FIG. 13 is different from the electrode structure of FIG. 9 in that the widths of a horizontal slit 253a′ and a vertical slit 253b′ of a cross pattern 253′ in a first subpixel region 250 are changed.

For example, as illustrated in FIG. 13, when a horizontal slit 353a and a vertical slit 353b of a cross pattern 353 in a second subpixel region 350 are formed to have a first width, the horizontal slit 253a′ of the cross pattern 253′ in the first subpixel region 250 may be formed to have a portion narrower than the first width and the vertical slit 253b′ of the cross pattern 253′ in the first subpixel region 250 may be formed to have a portion wider than the first width.

FIG. 13 illustrates an exemplary case where the horizontal slit 253a′ of the cross pattern 253′ in the first subpixel region 250 is formed to have a portion narrower than the first width and the vertical slit 253b′ of the cross pattern 253′ in the first subpixel region 250 is formed to have a portion wider than the first width. In another example, the horizontal slit 253a′ of the cross pattern 253′ in the first subpixel region 250 may be formed to have a portion wider than the first width and the vertical slit 253b′ of the cross pattern 253′ in the first subpixel region 250 may be formed to have a portion narrower than the first width. Also, in another example, the horizontal slit 253a′ and the vertical slit 253b′ of the cross pattern 253′ in the first subpixel region 250 may be formed to have a first width, one of the horizontal slit 353a and the vertical slit 353b of the cross pattern 353 in the second subpixel region 350 may be formed to have a portion wider than the first width, and the other of the horizontal slit 353a and the vertical slit 353b of the cross pattern 353 in the second subpixel region 350 may be formed to have a portion narrower than the first width.

As may be seen from the comparison between the light-transmitted images of FIGS. 10 and 14, visibility may be controlled by controlling the slit widths as above.

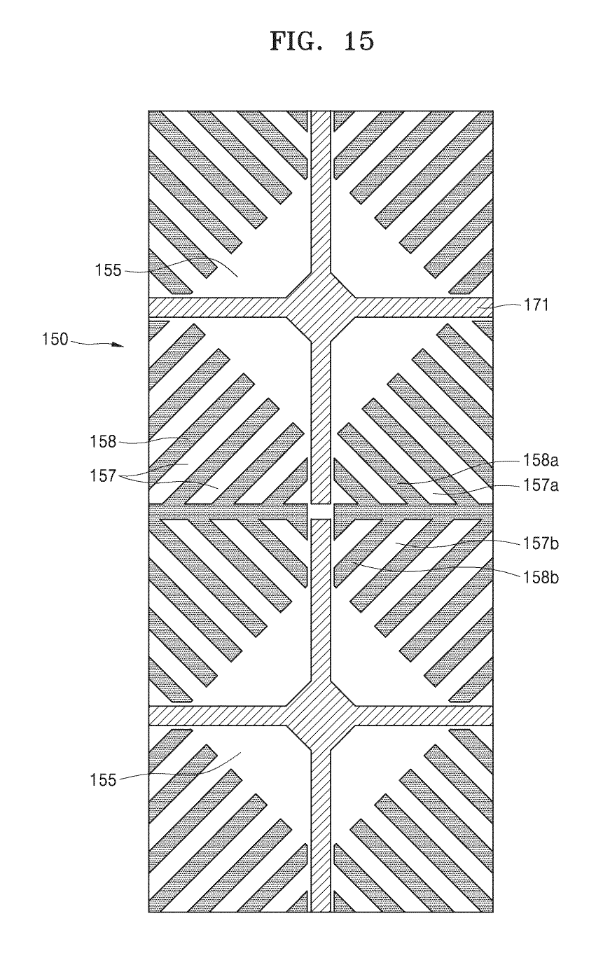

FIG. 15 illustrates an electrode structure of a liquid crystal display according to another embodiment of the present invention.

Referring to FIG. 15, a pixel electrode 150 may include a pair of plate electrodes 155 that are adjacent to each other, and slits 158 may be formed such that a plurality of minute branch electrodes 157 may extend in a diagonal direction outward from the plate electrodes 155. The plate electrodes 155 may be formed to have a diamond shape, and the minute branch electrodes 157 may be formed to extend in a diagonal direction from the sides of the plate electrodes 155. In this case, the minute branch electrodes 157 may be formed to alternate with each other between the plate electrodes 155.

For example, slits 158a and slits 158b may be formed to alternate with each other, so that minute branch electrodes 157a extending from one of the plate electrodes 155 and minute branch electrodes 157b extending from the other of the plate electrodes 155 may be formed to alternate with each other.

In this case, a distance between end portions of the minute branch electrodes 157 may be uniform between the plate electrodes 155. Since the distance between the end portions is uniform, a transmittance may be further increased.

The pixel electrode 150 may be provided on a lower substrate of the liquid crystal display. A reference numeral 171 denotes a cross slit of a common electrode provided on an upper substrate of the liquid crystal display.

As described above, according to the one or more of the above embodiments of the present invention, since at least some of the plurality of minute branch electrodes constituting the pixel electrode alternate with each other, the generation of an unstable texture may be reduced and thus bruising characteristics may be improved.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A liquid crystal display, comprising:
a pair of substrates; and
a pixel electrode and a common electrode disposed on the pair of substrates to face each other,
the pixel electrode comprising a plate electrode, a plurality of first minute branch electrodes extending inward from the plate electrode and alternating with each other, and a plurality of second minute branch electrodes extending outward from the plate electrode.

2. The liquid crystal display of claim 1, wherein the pixel electrode comprises:
a cross pattern at a center of the pixel electrode; and
the plate electrode surrounding the cross pattern,
wherein the plurality of first minute branch electrodes extend in a diagonal direction inward from the plate electrode and up to the cross pattern.

3. The liquid crystal display of claim 2, the pixel electrode comprises a partial extension structure formed in at least one of a partial boundary region located between the plate electrode and the plurality of first minute branch electrodes and a partial boundary region located between the plate electrode and the plurality of second minute branch electrodes.

4. The liquid crystal display of claim 2, wherein the common electrode comprises a slit pattern formed at a position corresponding to the plate electrode and having a smaller width than the plate electrode.

5. The liquid crystal display of claim 4, wherein an electrode portion formed inside the slit pattern of the common electrode has a diamond shape.

6. The liquid crystal display of claim 4, wherein the slit pattern of the common electrode comprises portions of different widths.

7. The liquid crystal display of claim 2, wherein the cross pattern comprises a horizontal slit and a vertical slit that cross each other and the plurality of first minute branch slits alternate with each other with respect to the horizontal slit and the vertical slit.

8. The liquid crystal display of claim 7, wherein at least one of the horizontal slit and the vertical slit comprises a slope portion having a width increasing toward a cross point thereof.

9. The liquid crystal display of claim 7, wherein at least one of the horizontal slit and the vertical slit has a uniform width.

10. The liquid crystal display of claim 7, wherein
a first subpixel region and a second subpixel region are provided in a pixel region,
the common electrode and the pixel electrode are formed in each of the first subpixel region and the second subpixel region,
the horizontal slit and the vertical slit of the cross pattern have a first width in one of the first subpixel region and the second subpixel region, and
in the other of the first subpixel region and the second subpixel region, the horizontal slit of the cross pattern has a width smaller than the first width and the vertical slit of the cross pattern has a width larger than the first width.

11. A liquid crystal display, comprising:
a pair of substrates; and
a pixel electrode and a common electrode disposed on the pair of substrates to face each other,
the pixel electrode comprising a first plate electrode and a second plate electrode that are adjacent to each other, a plurality of first minute branch electrodes extending in a diagonal direction outward from the first plate electrode, and a plurality of second minute branch electrodes extending in a diagonal direction outward from the second plate electrode, and
the plurality of first minute branch electrodes and the plurality of second minute branch electrodes alternating with each other between the first plate electrode and the second plate electrode.

12. The liquid crystal display of claim 11, wherein a distance between the first minute branch electrode and the second minute branch electrode is uniform between the first plate electrode and the second plate electrode.

13. The liquid crystal display of claim 12, wherein
the first plate electrode and the second plate electrode have a diamond shape, and
the plurality of first minute branch electrodes and the plurality of second minute branch electrodes extend in a diagonal direction from sides of the first plate electrode and the second plate electrode.

14. The liquid crystal display of claim 11, wherein
the first plate electrode and the second plate electrode have a diamond shape, and
the plurality of first minute branch electrodes and the plurality of second minute branch electrodes extend in a diagonal direction from sides of the first plate electrode and the second plate electrode.

15. The liquid crystal display of claim 11, wherein
a first subpixel region and a second subpixel region are provided in a pixel region, and
the common electrode and the pixel electrode are formed in each of the first subpixel region and the second subpixel region.

16. The liquid crystal display of claim 3, wherein
a first subpixel region and a second subpixel region are provided in a pixel region, and
the common electrode and the pixel electrode are formed in each of the first subpixel region and the second subpixel region.

17. The liquid crystal display of claim 2, wherein
a first subpixel region and a second subpixel region are provided in a pixel region, and
the common electrode and the pixel electrode are formed in each of the first subpixel region and the second subpixel region.

18. The liquid crystal display of claim 1, wherein
a first subpixel region and a second subpixel region are provided in a pixel region, and
the common electrode and the pixel electrode are formed in each of the first subpixel region and the second subpixel region.
